(19) United States
(12) Patent Application Publication
(10) Pub. No.: US 2007/0094848 A1
(43) Pub. Date: May 3, 2007

(54) Pliable handle on which a button can be installed

(76) Inventor: Chien-Hung Chen, Huli District (CN)

Correspondence Address: GREER, BURNS & CRAIN, 300 S WACKER DR, 25TH FLOOR, CHICAGO, IL, 60606, US

(21) Appl. No.: 11/262,390

(22) Filed: Oct. 28, 2005

(51) Int. Cl. B25G 1/10

(52) U.S. Cl. 16/431

(57) ABSTRACT

The present invention provides a pliable handle on which a button can be installed, relating to the handles of hand-held devices. It comprises a rigid core member, there is a bore in the rigid plastic core member along the longitudinal axis of the core member for locking the bottom of the central rod; a flexible outer sheath is disposed about the core member hermetically, and deformable gel is disposed between the core member and the outer sheath. A space for receiving the button which can move in radial direction is set in the core member, a through opening for button to be inserted through is disposed in the side wall of the core member, the side wall corresponds to the space; an outer annular flange is formed on the exterior surface of the core member which corresponds to the through opening; an opening is set on the flexible outer sheath for containing the outer annular flange of the core member; The opening of the outer sheath covers the outer annular flange of the core member. It prevents the gel from going into the inner of the core member and hindering the movement of the button, and prevents the gel from leaking outwards. It keeps the comfortable feeling of the pliable handle, and provides a facility for assembling the button

### FIELD OF INVENTION

The present invention generally relates to the structure of a handle of hand-held devices, such as handles of walking sticks, umbrellas and fish pole.

### BACKGROUND TECHNOLOGY

All kinds of pliable handles based on known technology have a flexible outer sheath disposed about the core member hermetically, and deformable gel is disposed between the core member and the outer sheath. In the structure of the pliable handle shown in FIG. 1, there is a bore 100 in the rigid plastic core member 1 along the longitudinal axis of the core member, and there is an upper groove 101 on the top of the core member 1, and a lower groove 102 is at the bottom of the core member 1. A cylindrical outer sheath 2 which is made of flexible rubber, has a flange in its top portion extending inwards and downwards, forming a upper flange 21; and has a flange in its bottom portion extending inwards and upwards, forming a lower flange 22. The upper flange 21 of the outer sheath is wedged into the upper groove 101 of the core member 1; the lower flange 22 of the outer sheath 2 is wedged into the lower groove 102 of the core member 1. The rigid plastic upper cap 11 is mushroom-shaped, and there is an opening through its center, insert its petiole into the central bore 100 of the core member 1, and fix it; the outer flange of the upper cap 11 makes the top of the outer sheath 2 press on the top of the core member 1 tightly, seal is implemented. The rigid plastic lower cap 12 is mushroom-shaped, and there is a opening in its center, insert its petiole into the central bore 100 of the core member 1, and fix it. The outer flange of the lower cap 12 makes the bottom of the outer sheath 2 press on the bottom of the core member 1 tightly, seal is implemented. The diameter of the central bore of the upper cap 11 is same as the diameter of the central bore of the lower cap 12, they formed a bore for rod together. The middle of the outer sheath 2 protrudes outwards, the outer of the core member 1 is concave inwards; the gap between the inner surface of the outer sheath 2 and the outer of the core member 1 can be filled with the gel 3 which is deformable. Because the pliable handle has a flexible outer and a hard core, the core member 1 provided a secure grip. The outer sheath 2 and the gel 3 will change conform to the shape of the hand. So the pliable handle provided a comfortable grip.

For controlling the unfurling and furling in some hand-held umbrellas, there is a clasp in the central rod of an umbrella, the clasp is attached to a slip cover to which many subordinate rods of umbrella is connected. When the umbrella is furled, the clasp locked the slip cover and made umbrella furl. The clasp is connected to a button, after pressing the button the clasp is detached from the slip cover, and the umbrella is unfurled. When the umbrella is furled, the clasp locked the slip cover again. For beauty and using conveniently, a through opening is set in the side wall of the core member, containing a button. When people grip the pliable handle, they can press the button with their thumb, making the clasp is detached from the slip cover, and the umbrella is unfurled. According to the structure of above-mentioned pliable handle, a through opening which contains a button in the side wall of the core member, when people grip the pliable handle, the gel may be leaked from the gap between the through opening and a button into the space between the inside of the core member and central rod of umbrella, it may hinder the movement of the button at worst. Additionally, if a button through the outer sheath, the gel may be leaked from the gap between the outer sheath and a button and go out of the outer sheath.

Some handles of hand-held devices, such as the handles of walking stick, fish pole, for using conveniently at night and the function of caution, a through opening is set in the side wall of the core member, containing a button battery, small bulb, luminous diode and so forth and a button switch. When people grip the pliable handle, they can press the button switch with their thumb, the button battery and luminous components form a closed circuit in series, the pliable handle radiated at night by the light of electrical luminous component, so the people who is far away can get the caution, and know the position of user. If the handle having a button component has the structure the same as the above-mentioned pliable handle's, there is an above-mentioned gel-leak problem.

### BRIEF SUMMARY OF THE INVENTION

The present utility model provided a pliable handle, in which the gel can not be leaked into the inside of the core member and out of the outer sheath, and a button can be fixed. The shape of the pliable handle is beautiful.

The technical project of the present utility is:

A pliable handle on which a button can be installed, which comprises a rigid core member with a bore set in the core member along the longitudinal axis of the core member for locking the bottom of the central rod; a flexible outer sheath is disposed about the core member hermetically, and deformable gel is disposed between the core member and the outer sheath;

wherein in the core member there is a space for containing the button which can move in radial direction, and there is a through opening for receiving the button in the side wall of the core member, the side wall corresponds to the said space; an outer annular flange is formed on the exterior surface of the core member corresponding to the through opening; an outer annular flange is formed on the outer of the core member, which corresponds to the through opening; an opening is set on the flexible outer sheath for receiving the outer annular flange of the core member; the opening of the outer sheath covers the outer annular flange of the core member.

For enhancing the seal between the outwards extending annular flange of the core member and the upper opening of the outer sheath: an annular groove is set on the outer of the upper outer flange of the said core member; an inwards extending annular flange is set inside of the upper opening of the outer sheath; the inner flange of the opening of the outer sheath wedges into the groove of the outer flange of the core member.

Special commendation: a rigid cover board of button bore, which corresponds to the through opening, is pressed on the vicinity of the opening of the outer sheath, the opening of the outer sheath hermetically covers the outer flange of the core member.

A structure of cover board, which is beautiful and assembled easily, is:

said cover board has 2 securing flanges, which extend upwards and downwards respectively, the said 2 securing flanges correspond to the top and the bottom of the core member respectively.

Specially, a rigid upper cap is set on the top of the said core member, a rigid lower cap is set on the bottom of the said core member; there are 2 outwards extending annular shoulders around the top portion and the bottom portion of the core member, and there is a hermetical annular groove in the middle of each shoulder; 2 hermetical loops are set at the top and at the bottom of the core member, the two hermetical loops are parallel and extend inwards; the upper hermetical loop on the top of the outer sheath is wedged into the gap between the core member and the upper cap, the lower hermetic loop on the top of the outer sheath is wedged into the hermetical groove of upper shoulder of the core member; the lower hermetic loop at the bottom of the outer sheath is wedged into the gap between the core member and the lower cap, the upper hermetical loop at the bottom of the outer sheath is wedged into the hermetical groove of lower shoulder of the core member; the ends of securing flanges of the cover board are secured to the upper cap and lower cap respectively.

Preferably, 2 bores are respectively formed on the said upper cap and said lower cap, the ends of securing flanges of the cover board are wedged into the bores on the said upper cap and said lower cap respectively.

A method of forming a pliable handle on which a button can be installed, wherein the steps are as follow:

Provide a rigid core member inside which a space for receiving a button which is moveable in radial direction is provided, an through opening corresponding to the space for the button to insert through is disposed on the side wall of the core member, an outwards extending annular flange corresponding to the through opening is provided on the outer wall of the core member, and an annular groove is disposed on the outer surface of the outwards extending annular flange;

Provide a flexible outer sheath which can be disposed about the core member hermetically, the flexible outer sheath includes a opening for receiving the outwards extending annular flange of the core member, an inwards extending annular flange is disposed on the bottom of the inner surface of the opening of the outer sheath;

Get suitable capacity of gel according to the capacity of the gel containing space defined between the flexible outer sheath and the core member;

Have the gel cover one side of the outer surface of the core member where is away from the outwards extending annular flange;

Enlarge the top opening of the flexible outer sheath to enable the flexible outer sheath to be sleeved about the core member;

Align the opening of the outer sheath with the outwards extending annular flange of the core member to have the inwards extending annular flange of the opening of the outer sheath be inserted into the recess of the outwards extending annular flange of the core member, the gel is sealed between the outer surface of the core member and a portion of the inner wall of the outer sheath where is away from the opening of the outer sheath.

The present utility is a pliable handle on which a button can be installed, the outwards extending annular flange of the through opening of the side wall of the core member cooperates with the opening of the flexible outer sheath, a rigid cover board presses on the opening of the outer sheath, the opening of the outer sheath covers the outwards extending annular flange of the core member hermetically. Effectively, the gel-leak from the through opening of side wall of the core member into the inner of the core member and from the opening of the outer sheath is prevented. It kept the comfortable grasp, and provided a facility for assembling the button. The inner flange of the outer sheath wedges into the groove of the outer flange of the core member, further, enhancing the seal between the outer flange of the core member and the opening of the outer sheath. Specially, a rigid upper cap and a rigid lower cap are set at the bottom and on the top of the core member, fixing and sealing the proximal end and distal end of the outer sheath, the ends having 2 hermetical loop respectively, the ends of the securing flanges are fixed on the upper cap and the lower cap respectively; the seal between the core member and the proximal end, the distal end of the outer sheath is good and the assembly is easy. Bores are set on the upper cap and the lower cap, fixing the ends of the securing flanges of the securing cover board, simple structure, it is easy for implementing and assembling.

### BRIEF DESCRIPTION OF THE DRAWINGS

FIG. 1 is a cross-sectional view of the pliable handle based on the exiting technology.

FIG. 2 is an exploded perspective view of the exemplary embodiment of the pliable handle on which a button can be installed of the present utility model.

FIG. 3 is an exploded perspective view of the exemplary embodiment of FIG. 2 being viewed from another point.

FIG. 4-1 is a front view of the upper cap of the exemplary embodiment of FIG. 2.

FIG. 4-2 is a cross-sectional view of the upper cap of the exemplary embodiment of FIG. 2.

FIG. 4-3 is a right view of the upper cap of the exemplary embodiment of FIG. 2

FIG. 5-1 is a front view of the core member of the exemplary embodiment of FIG. 2

FIG. 5-2 is a cross-sectional view of the core member of the exemplary embodiment of FIG. 2

FIG. 5-3 is a right view of the core member of the exemplary embodiment of FIG. 2

FIG. 6-1 is a front view of the outer sheath of the exemplary embodiment of FIG. 2

FIG. 6-2 is a cross-sectional view of the outer sheath of the exemplary embodiment of FIG. 2

FIG. 6-3 is a right view of the outer sheath of the exemplary embodiment of FIG. 2

FIG. 7-1 is a front view of the lower cap of the exemplary embodiment of FIG. 2.

FIG. 7-2 is a cross-sectional view of the lower cap of the exemplary embodiment of FIG. 2.

FIG. 7-3 is a right view of the lower cap of the exemplary embodiment of FIG. 2.

FIG. 8-1 is a front view of the cover board of the exemplary embodiment of FIG. 2.

FIG. 8-2 is a cross-sectional view of the cover board of the exemplary embodiment of FIG. 2.

FIG. 8-3 is a right view of the cover board of the exemplary embodiment of FIG. 2.

FIG. 9 is a cross-sectional view of the assembled exemplary embodiment of FIG. 2.

FIG. 10 is a perspective view of the assembled exemplary embodiment of FIG. 2.

FIG. 11 is a perspective view of the assembled exemplary embodiment of FIG. 2 being viewed from another point.

### DETAILED DESCRIPTION OF THE PREFERRED EMBODIMENTS

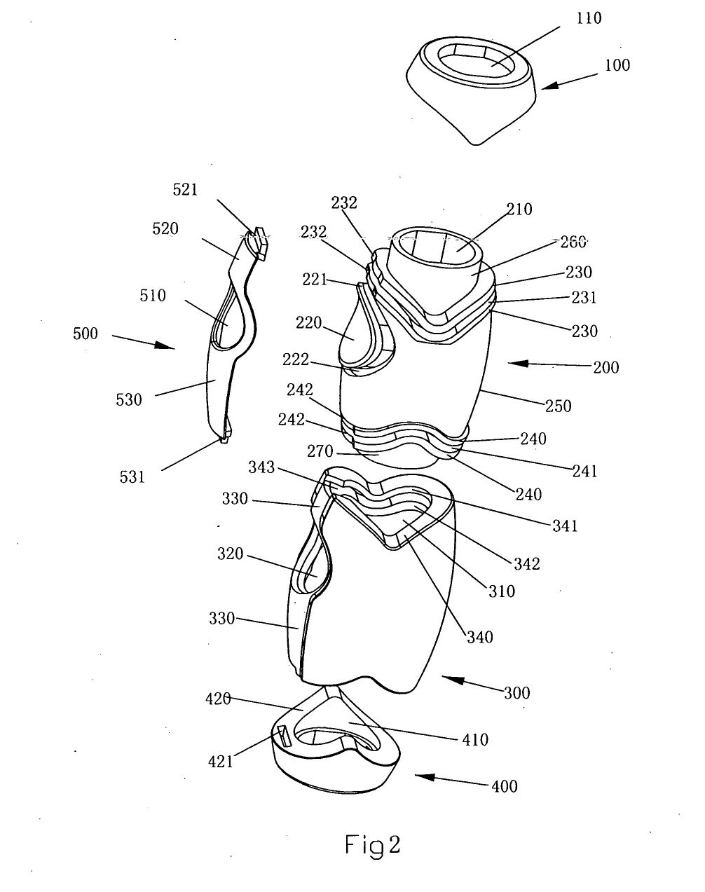

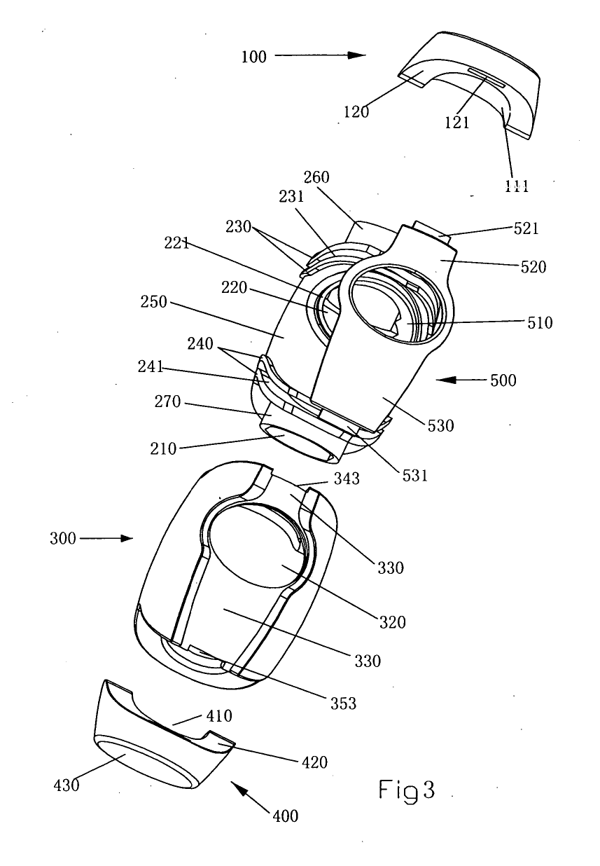

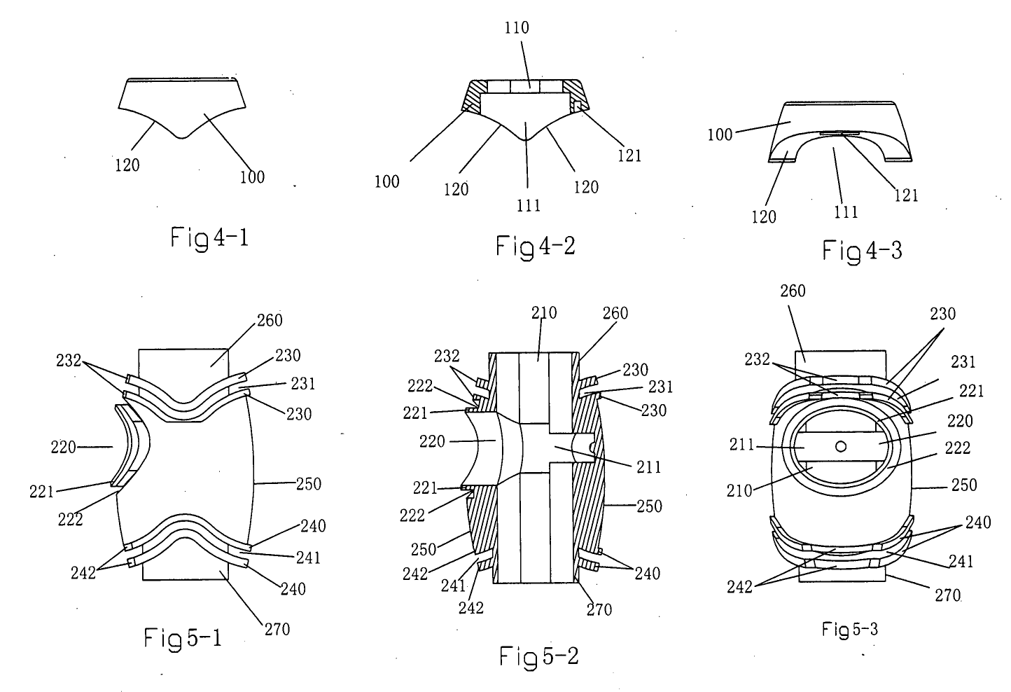

The exploded structure of the embodiment of the pliable handle on which a button can be installed of the present utility model, as FIGS. 2 and 3 show. The pliable handle comprising: an upper rigid plastic cap 100, a rigid plastic core member 200, a flexible outer sheath 300 which is made of rubber or plastic, a lower rigid plastic cap 400, a rigid plastic cover board 500 and the gel 600.

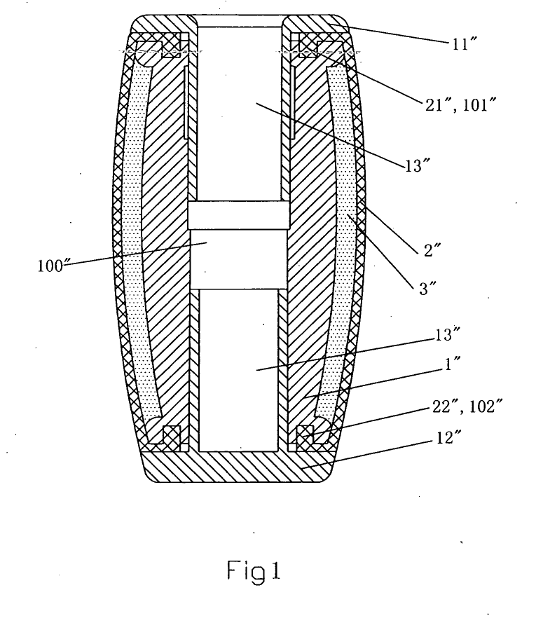

Referring to FIG. 4-1, FIG. 4-2, FIG. 4-3, a longitudinal bore 110 for central rod is set in the center of the upper cap 100, the diameter of the lower portion 111 of the longitudinal bore 110 is augmented for receiving the upper joint of the core member 100. A pair of protuberances is set at the lower portion of the upper cap 100, they divided the bottom surface 120 into 2 curvedd surfaces which curveds upwards, an oblong bore 121 is set in the middle of one curvedd surface.

Referring to FIG. 5-1, FIG. 5-2, FIG. 5-3, the core member 200 is in drum shape, except the upper end and lower end, its outer surface extends inward to contain the gel. A bore 210 is set in the core member 200 along the longitudinal axis of the core member, for locking the bottom of the central rod. A groove 211 which can contain a button that can move in radial direction is set in the core member 200, a through opening 220 which corresponds to the groove 211 in the side wall of the core member 200, containing the button; a outwards extending annular flange 221 is formed on the outer 250 of the core member, which corresponds to the through opening 220. An annular groove is formed on the outer of the outwards extending annular flange 221 of the core member 200. An upper annular shoulder 230 is formed on the top of the core member 200, which protrudes outwards. The 2 V-shaped curvedd portions are in the protuberance of the upper cap 100, which corresponds to the upper annular shoulder 230, a upper hermetical annular groove 231 is formed in the middle of the upper annular shoulder 230. a lower annular shoulder 240 is formed at the bottom of the core member 200, which protrudes outwards. The 2 V-shaped curvedd portions are in the protuberance of the lower cap 400, which corresponds to the lower annular shoulder 240. a lower hermetical annular groove 241 is formed in the middle of the lower annular shoulder 240 a cylindrical upper joint 260 is extended from the center of the top of the core member 200 a cylindrical lower joint 270 is extended from the center of the bottom of the core member 200. For assembling the cover board 500, a upper surface 232 and a lower surface 242 is formed in the positions of the lower annular shoulder 240 and the upper annular shoulder 230 of the core member 200, the position corresponds to the outwards extending annular flange 221.

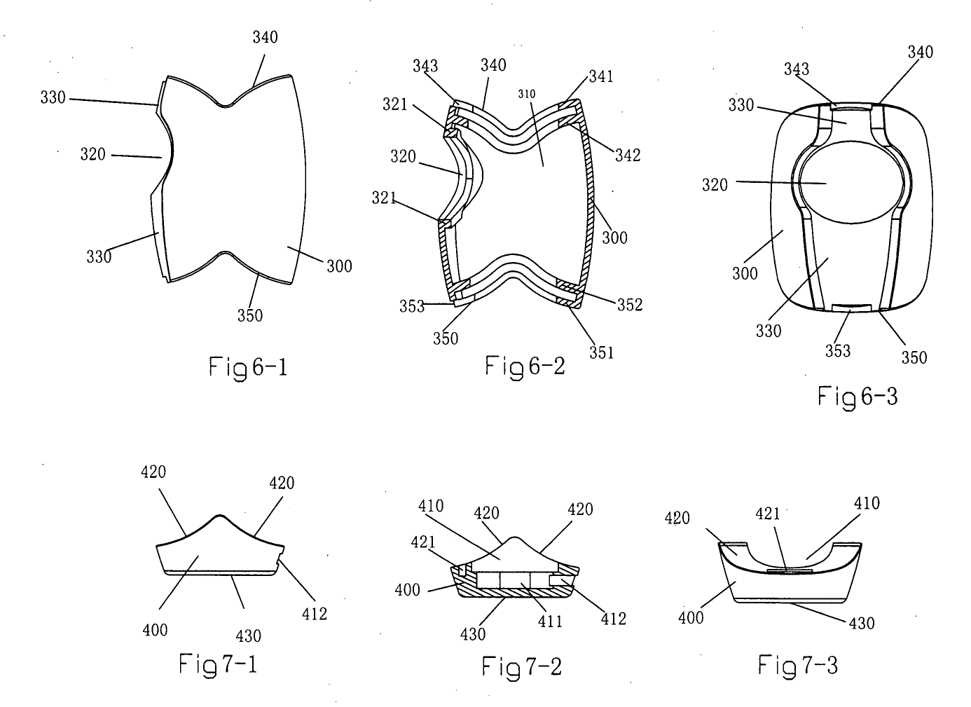

Referring to FIG. 6-1, FIG. 6-2, FIG. 6-3, the hollow outer sheath is in drum shape. The inner space 310 can contain the core member 200. The opening 320 is set on the side wall of the outer sheath 300, which contains the outwards extending annular flange 221 of the core member 200. An inwards extending annular flange 321 which corresponds to the groove 222 of the outwards extending annular flange 221 of the core member is set inside of the opening 320 of the outer sheath 300. the hermetical loops 341 342 is formed inside the top 340 of the outer sheath 300, the hermetical loops 341 342 are parallel and protruded inwards; there are 2 V-shaped curved portions in the hermetical loops 341 342 which correspond to the upper annular shoulder 230 of the core member. The hermetical loops 351 352 is formed inside the bottom 350 of the outer sheath 300, the hermetical loops 351 352 are parallel and protruded inwards, there are 2 V-shaped curved portions in the hermetical loops 351 352 which correspond to the lower annular shoulder 240 of the core member. A longitudinal groove 330 is on the outer of the outer sheath 300 which corresponds to the opening 320, for assembling the cover board 500; a incision 343 which extended into the hermetical loops 341 is set on the top of groove 330, a incision 353 which extended into the hermetical loops 351 is set at the bottom of groove 330.

Referring to FIG. 7-1, FIG. 7-2, FIG. 7-3, a pair of protuberances which extend downwards are on the top of the lower cap 400, they divide the top surface 420 into 2 curved surfaces which curved downwards, an oblong bore 421 is set in the middle of one curved surface. A longitudinal bore 410 which contains the lower joint 270 of the core member 100 is set in the middle of the top surface of the lower cap 400, the diameter of the bottom 411 of the longitudinal bore 410 is minified, which communicates with the bore 412. The bottom surface 430 of the lower cap 400 is smooth.

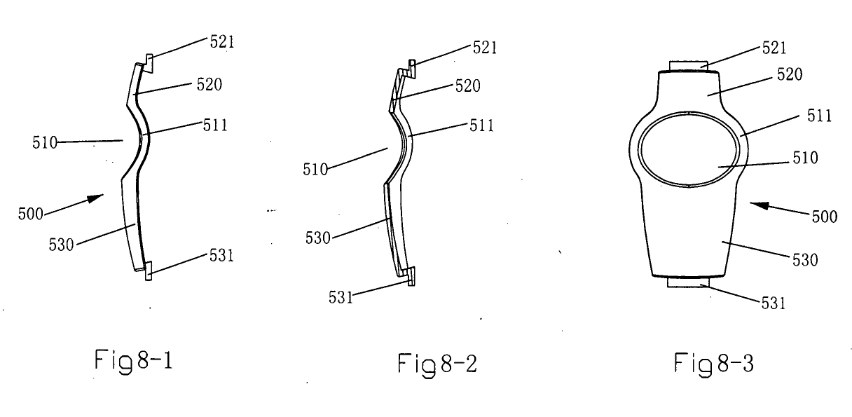

Referring to FIG. 8-1, FIG. 8-2, FIG. 8-3, a button bore 510 which corresponds to the through opening 220 of the side wall of the core member 200 is set on the cover board 500. the securing flange 520 is extended upwards from the press-loop 511 of the middle of the cover board 500, the securing flange 530 is extended downwards from the press-loop 511 of the middle of the cover board 500; the end of the upper securing flange 520 of the cover board 500 is minified and folded into the upper end 521, the end of the lower securing flange 530 of the cover board 500 is minified and folded into the upper end 531.

During the assembly, measure the gel at first and then get the quantificational gel. Put the gel on one side of outer 250 of the core member 200 which is far from the outwards extending annular flange 221, the gel is extruded in slice shaped, the core member 200 with the gel is put into the inner space 310 of the outer sheath 300. the opening 320 of the outer sheath 300 faces the outwards extending annular flange 221 of the core member 200, inwards extending annular flange 321 of the opening 320 of the outer sheath 300 wedges into the groove 222 of the outwards extending annular flange 221 of the core member 200. the hermetical loop 341 which is on the top of the outer sheath 300 engages with the top surface of the core member 200, the hermetical loop 342 which is on the top of the outer sheath 300 wedges into the upper hermetical annular groove 231 of the upper annular shoulder 230 of the core member 200; the lower hermetical loop 351 which is at the bottom of the outer sheath 300 engages with the bottom surface of the core member 200, the upper hermetical loop 352 which is at the bottom of the outer sheath 300 wedges into the lower hermetical annular groove 241 of the lower annular shoulder 240 of the core member 200. The gel is sealed between the inner wall of the outer sheath 300, which is far from the opening 320 of the outer sheath 300, and the outer 250 of the core member 200. the gel is formed the gel-body 600.

The button bore 510 of the cover board 500 faces the through opening 220 of the side wall of the core member 200, putting the cover board 500 on the longitudinal groove 330 which is on the surface of the outer sheath 300, the press-loop 511 which is in the middle of the cover board 500 is put on the wide portion of the middle of the groove 330, the upper end 521 of the securing flange 520 of the cover board 500 wedges into incision 343 of the longitudinal groove 330, the upper end 531 of the securing flange 530 of the cover board 500 wedges into incision 353 of the longitudinal groove 330. The gel is put on the outer of upper joint 260 of the core member 200 and the inner of the lower portion 111 of the longitudinal bore 110, respectively. the lower portion 111 of the longitudinal bore 110 faces the upper joint 260 of the core member 200, the oblong bore 121 of the bottom surface 120 of the upper cap 100 face the upper end 521 of the securing flange 520 of the cover board 500, the upper cap 100 presses on the upper joint 260 of the core member 200. the bottom surface of the upper cap 100 presses on the hermetical loop 341 which is on the top of the outer sheath 300, the gap between the bottom surface of the upper cap 100 and the top surface of the core member 200 is sealed.

Coat the gel on the outer of the lower joint 270 of the core member 200 and the inner of the longitudinal bore 410 of the lower cap 400, respectively. the longitudinal bore 410 of the lower cap 400 faces the lower joint 270 of the core member 200, the oblong bore 421 of the top surface 420 of the lower cap 400 faces the upper end 531 of the securing flange 530 of the cover board 500, the lower cap 400 presses on the lower joint 270 of the core member 200. the top surface of the lower cap 400 presses on the lower hermetical loop 351 which is at the bottom of the outer sheath 300, the gap between the top surface of the lower cap 400 and bottom surface of the core member 200 is sealed. At this point, the inwards extending annular flange 321 of the opening 320 of the outer sheath 300 is wedged into the groove 222 of the outwards extending annular flange 221 of the core member 200 by the press-loop 511 of the middle of the cover board 500, and it is sealed strictly. The upper securing flange 520 and the lower securing flange 530 press the 2 ends of groove 330 on the upper surface 232 of the upper annular shoulder 230 and the lower surface 242 of the lower annular shoulder 240, respectively. The bottom of the groove 330 of the outer sheath 300 is nipped between the cover board 500 and the outer 250 of the core member, the gel is disposed between the bottom of the groove 330 of the outer sheath 300 and the outer 250 of the core member.

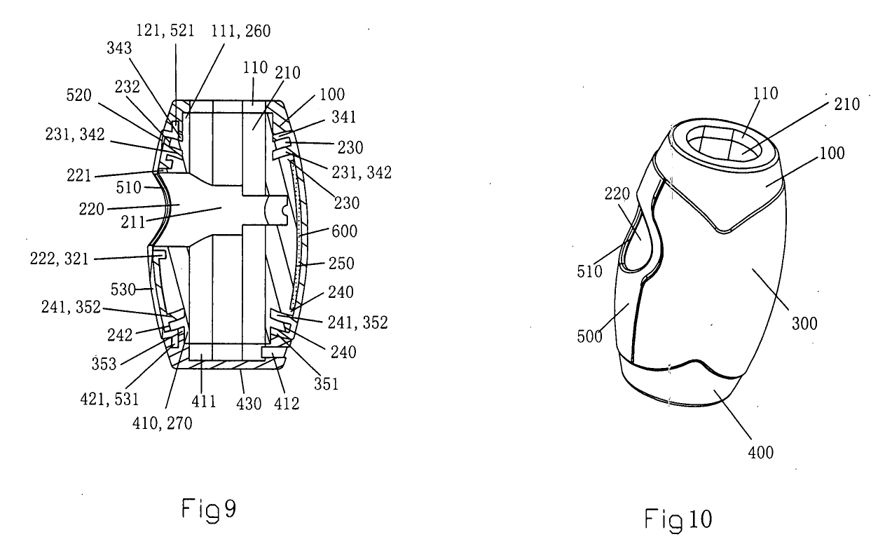

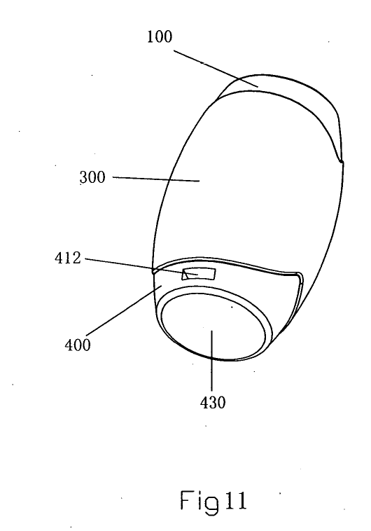

The cross-sectional view of the present embodiment after assembly, as FIG. 9 shows, the stereogram, as FIGS. 10 and 11 shows, after assembly, the flexible outer sheath 300 is nipped by the rigid upper cap 100 and the lower cap 400, it is fixed securely around the core member 200. The rigid cover board 500 presses on the periphery of the opening 320 of the outer sheath 300, the opening 320 of the outer sheath 300 is fixed on the outwards extending annular flange 221 of the core member 200. at this point, the bottom of the buckle can be installed in the bottom 411 of the longitudinal bore 410 through the longitudinal bore 110 of the upper cap 100 and the bore 210 of the core member 200 downwards, and through the lower cap 400. the ring of the buckle is led from the bore 421. throuth the button bore 510 of the cover board 500 and the through opening 220 of the side wall of the core member 200, the button and its append components are installed in the groove 211 in the side wall of the core member 200. at last, through the longitudinal bore 110 of the upper cap 100 and the bore 210 of the core member 200, the central rod of hand-held device is installed. The present embodiment is secured to the umbrella, walking stick and fish pole. When people griped the outer sheath 300, the deformable gel disposed between the outer sheath 300 and the core member 200 will deform and conform to the shape of the hand, the feel of hand is comfortable.

As mentioned above, it is the preferred embodiment of the present utility model. It will not limit the scope of the present utility model. The equivalent change and the modification based on the contents of the technical project and the specification of the present utility model belong to the scope of the present utility model.

1. A pliable handle on which a button can be installed, comprising: a rigid core member with a bore set in the core member along the longitudinal axis of the core member for locking the bottom of the central rod; a flexible outer sheath is disposed about the core member hermetically, and deformable gel is disposed between the core member and the outer sheath;
wherein in the core member there is a space for containing the button which can move in a radial direction, and there is a through opening for receiving the button in a side wall of the core member, the side wall corresponds to the said space; an outer annular flange is formed on an exterior surface of the core member corresponding to the through opening; an outer annular flange is formed on the outer of the core member, which corresponds to the through opening; an opening is set on the flexible outer sheath for receiving the outer annular flange of the core member; the opening of the outer sheath covers the outer annular flange of the core member.

2. The pliable handle on which a button can be installed as recited in claim 1, wherein an annular groove is formed on the outer of the outer annular flange of the core member; an inner annular flange is set inside the opening of the flexible outer sheath; the inner annular flange which is set inside of the opening of the flexible outer sheath is wedged into the annular groove formed on the outer of the outer annular flange of the core member.

3. The pliable handle on which a button can be installed as recited in claim 1, wherein a rigid cover board of a button bore, which corresponds to the through opening, is pressed on the vicinity of the opening of the outer sheath, the opening of the outer sheath hermetically covers the outer flange of the core member.

4. The pliable handle on which a button can be installed as recited in claim 3, wherein said cover board has two securing flanges, which extend upwards and downwards respectively, the said two securing flanges correspond to the top and the bottom of the core member respectively.

5. The pliable handle on which a button can be installed as recited in claim 4, wherein a rigid upper cap is set on the top of the said core member, a rigid lower cap is set on the bottom of the said core member; there are two outwards extending annular shoulders around the top portion and the bottom portion of the core member, and there is a hermetical annular groove in the middle of each shoulder; two hermetical loops are set at the top and at the bottom of the core member, the two hermetical loops are parallel and extend inwards; the upper hermetical loop on the top of the outer sheath is wedged into the gap between the core member and the upper cap, the lower hermetic loop on the top of the outer sheath is wedged into the hermetical groove of an upper shoulder of said shoulders of the core member; the lower hermetic loop at the bottom of the outer sheath is wedged into the gap between the core member and the lower cap, the upper hermetical loop at the bottom of the outer sheath is wedged into the hermetical groove of a lower shoulder of said shoulders of the core member; the ends of securing flanges of the cover board are secured to the upper cap and lower cap respectively.

6. The pliable handle on which a button can be installed as recited in claim 5, wherein two bores are respectively formed on the said upper cap and said lower cap, the ends of securing flanges of the cover board are wedged into the bores on the said upper cap and said lower cap respectively.

7. A method of forming a pliable handle on which a button can be installed, wherein the steps are as follows:
providing a rigid core member inside which a space for receiving a button which is moveable in radial direction is provided, an through opening corresponding to the space for the button to insert through is disposed on the side wall of the core member, an outwards extending annular flange corresponding to the through opening is provided on the outer wall of the core member, and an annular groove is disposed on the outer surface of the outwards extending annular flange;
providing a flexible outer sheath which can be disposed about the core member hermetically, the flexible outer sheath includes an opening for receiving the outwards extending annular flange of the core member, an inwards extending annular flange is disposed on the bottom of the inner surface of the opening of the outer sheath;
obtaining suitable capacity of gel according to the capacity of the gel containing space defined between the flexible outer sheath and the core member;
having the gel cover one side of the outer surface of the core member away from the outwards extending annular flange;
enlarging the top opening of the flexible outer sheath to enable the flexible outer sheath to be sleeved about the core member; and
aligning the opening of the outer sheath with the outwards extending annular flange of the core member to have the inwards extending annular flange of the opening of the outer sheath be inserted into the recess of the outwards extending annular flange of the core member, the gel is sealed between the outer surface of the core member and a portion of the inner wall of the outer sheath away from the opening of the outer sheath.

8. The pliable handle on which a button can be installed as recited in claim 2, wherein a rigid cover board of a button bore, which corresponds to the through opening, is pressed on the vicinity of the opening of the outer sheath, the opening of the outer sheath hermetically covers the outer flange of the core member.
